(19) United States
(12) Patent Application Publication
(10) Pub. No.: US 2026/0094856 A1
(43) Pub. Date: Apr. 2, 2026

(54) DEVICE AND METHOD FOR PRESSING TOGETHER JOINING PARTNERS DURING BATTERY MODULE ASSEMBLY

(71) Applicant: GROB-WERKE GmbH & Co. KG, MINDELHEIM (DE)

(72) Inventor: Joshua WILBILLER, DIRLEWANG (DE)

(21) Appl. No.: 19/327,339

(22) Filed: Sep. 12, 2025

(30) Foreign Application Priority Data
Sep. 30, 2024 (EP) 24203611.9

(51) Int. Cl. H01M 10/04; B23K 26/02; B23K 26/21; B23K 101/38; H01M 50/516

(52) U.S. Cl. CPC H01M 10/0404; B23K 26/02; B23K 26/21; H01M 10/0481; H01M 50/516; B23K 2101/38

(57) ABSTRACT

A device for pressing at least one first joining partner against at least one second joining partner when joining battery cells and cell connectors during battery assembly. The device has several pneumatic pistons that are designed to form a shared gas volume during operation, and hold-down devices that are designed to be pressed simultaneously against the at least one first joining partner by the pneumatic pistons.

### CROSS-REFERENCES TO RELATED APPLICATIONS

This application claims the benefit of European Patent Application Number 24203611.9 filed on Sep. 30, 2024, the entire disclosure of which is incorporated herein by way of reference.

### FIELD OF THE INVENTION

The invention relates to a presser device for pressing at least one first joining partner against at least one second joining partner when joining battery cells and cell connectors during battery module assembly. The invention also relates to a joining device for joining battery cells and cell connectors as part of battery module assembly with at least one such presser device. The invention further relates to a pressing method for pressing at least one first joining partner against at least one second joining partner when joining battery cells and cell connectors during battery module assembly. Finally, the invention relates to a joining method for joining battery cells and cell connectors during battery module assembly using such a pressing method.

### BACKGROUND OF THE INVENTION

From EP 3 345 717 A1, reference [1], a joining device and a joining method for joining cell connectors and battery cells are known, in which a presser system comprising a single hold-down device approaches each joining point individually.

For general technological background information on the assembly of battery modules, reference is made to the following: [2] Brochure “Montageprozess eines Batteriepacks” (“Assembly process of a battery pack”) by RWTH Aachen, downloaded on Aug. 30, 2024, from https://www.pem.rwth-aachen.de/global/show_document.asp?id=aaaaaaaaaaoqiyk.

In order to join cell connectors, such as metal sheets or metal tabs, and battery cells, e.g. by welding, the joining partners are pressed together during battery cell assembly. In battery module assembly, the pressing operation or the creation of the “zero gap” between the cell connector/cell contacting system and battery cell, especially a prismatic battery cell and/or pouch cell, frequently takes place using hold-down devices which are individually mechanically spring-loaded. Depending on the module type of the battery cells, these hold-down devices are arranged in series horizontally (i.e. the poles are not arranged on top but laterally of the cell (blade cell, pouch cell)) or vertically (i.e. the poles are arranged on top of the battery cell (prismatic cell, pouch cell)). This allows cell connectors to be pressed onto battery cells at several joining points simultaneously.

One or more pressure spring packs are normally used for pressing the hold-down devices.

The pressing forces per hold-down device must be adjusted individually via the preload of the pressure spring packs using shims or a screw connection.

Due to their manufacturing tolerances, the individual pressure spring packs per hold-down device exhibit a high dispersion of forces at the same preload. Therefore, the pressing force must be adjusted individually for each hold-down device, which is time-consuming. This leads to considerable efforts for initial commissioning and setting and to correspondingly high costs.

Depending on the customer component and typology of the battery module system, i.e., depending on the number of battery cells and their positioning relative to each other in the module—there may be interfering contours on the component (e.g. plastic lugs on the cell contacting system), it is possible that certain hold-down devices must not be pressed during the process, depending on the type. When compression springs are used, this leads to increased design complexity and additional assemblies that restrain certain hold-down devices depending on the type.

A broken spring in the pressure spring pack and the resulting reduction in pressing force cannot be detected during the process. This can lead to an increased reject rate for the system.

Tolerance-related height differences in the battery cells can also occur, which can cause the pressing force exerted by the pressure spring-loaded hold-down devices to be too high or too low.

### SUMMARY OF THE INVENTION

Therefore, in at least one aspect, the invention is based on the problem of providing an improved device and an improved method for pressing at least one first joining partner against at least one second joining partner when joining battery cells and cell connectors during battery module assembly, in which especially the adjustment effort is reduced and the process reliability is increased. Furthermore, additional components that are dependent on the workpiece type should also be reduced.

These and other problems, which are mentioned in the following description or can be recognized by a person of ordinary skill in the art, are solved by the subject matter of one or more embodiments described herein.

According to a first aspect, the invention provides a presser device for pressing at least one first joining partner against at least one second joining partner when joining battery cells and cell connectors during battery module assembly, wherein the presser device comprises several pneumatic pistons that are designed to form a shared gas volume during operation, and a plurality of hold-down devices that are designed to be pressed simultaneously against the at least one first joining partner by means of the pneumatic pistons.

The pneumatic pistons now control the hold-down devices by means of pressure rather than moving them in a path-controlled manner. This means that the hold-down devices are each extended until a predetermined pressure is reached. The presser device according to the invention thus makes it possible to reduce the effort required for adjustment or commissioning and to increase process reliability.

Accordingly, several pneumatic pistons are provided which form a shared gas volume especially during the pressing operation. For example, the pistons together with lines and a compressed gas source form said shared gas volume. In other words, the pistons participate in the shared gas volume at least during the pressing operation, each of these pistons forming part of the shared gas volume. For example, at least during the pressing operation, the pistons are connected to a shared compressed gas source which supplies the pneumatic pistons assigned to each other with shared gas pressure. A shared gas volume can be formed in different ways. For example, the pistons are connected in series, with a connecting line that is open during operation being provided in each case between adjacent pistons, so that the gas pressure from a compressed gas source is set across all pistons connected in series. In other designs, the pistons are connected in parallel, in particular all of them are connected to a shared distribution line. The lines can be permanently open and supplied via a central device, e.g. a valve or a pressure regulator. However, it is also possible to provide several valves, in which case a switching logic, for example a control unit, in particular computer-implemented, is configured in such a way that it switches the valves for operation so that the pistons are connected to a shared compressed gas source during operation and thus form the shared gas volume. It is particularly preferable for valves provided on the individual pistons to be pneumatically controlled. The valves can be connected in series.

In some embodiments, the presser device comprises at least one pressure regulator connected to the pistons forming a shared gas volume during the pressing operation, for controlling a pressing force with which the hold-down devices movable by means of the pistons press against the at least one first joining partner.

In some embodiments, 2 to 100, in particular 10 to 100, more particularly 20 to 80 hold-down devices are provided that can be controlled jointly by pistons forming a shared gas volume during the pressing operation.

In some embodiments, it is provided that in addition to several first hold-down devices, which can be jointly controlled by means of the pistons forming a shared gas volume during the pressing operation, at least one or more second hold-down devices with associated further pneumatic pistons are provided that can be controlled separately. A single second hold-down device may be provided, wherein the one or more pistons that move the second hold-down device can be supplied separately with (different) gas pressure. However, the pistons assigned to the second hold-down devices can in turn also form a shared (additional) gas volume, which can be supplied with (also different) gas pressure separately from the gas volume of the first pistons, in the same way as the pistons assigned to the first hold-down devices. In this way, different groups of hold-down devices, even including more than two, can be formed, which can be supplied with different pressures.

In some embodiments, it is provided that each hold-down device can be moved by at least one first piston and a second piston spaced apart from the first piston. Preferably, the first pistons and the second pistons of each hold-down device form a shared gas volume during the pressing operation. In particular, this allows the hold-down device to be moved uniformly, with a space for a joining operation, for example a channel for a welding beam, being formed between the first and the second piston. Since the first and the second piston form a shared gas volume, it is ensured that the same pressure is applied to each piston per hold-down device. In some embodiments, however, a single piston per hold-down device is sufficient. In this case, it is advantageous for the piston to have a recess to form the space for the joining process. For example, the piston is ring-shaped with a through channel or is arched or U-shaped.

In some embodiments, the presser device has a base on which the hold-down devices are movably guided by means of the pistons, the base having at least one compressed gas distributor for distributing compressed gas to the pistons, the compressed gas distributor being connected on the one hand to a pressure source and on the other hand to the pistons. Several bases may also be provided. For example, the hold-down devices are arranged on several bases in a distributed manner. This is particularly advantageous in the case of very long presser devices or presser devices that provide several different groups of hold-down devices to be controlled differently.

In some embodiments, it is provided that from the pneumatic pistons which are designed to form a shared gas volume during operation, at least one, several or all can be connected in a switchable manner to a shared compressed gas source by means of its (their) own valve. In some embodiments, the valves are connected in series. In some embodiments, the valves are pneumatically controlled and can be controlled jointly, for example by pneumatic control connections being selectively pressurized or depressurized.

In some embodiments, the pistons to be actuated jointly are connected to a shared pressure source, whereas pistons that are not to be actuated for component-specific reasons are not connected to the pressure source. This can be achieved by providing or not providing pressure connection lines, e.g., on bores at the base. This allows easy adaptation to component-specific conditions.

In other embodiments, valves assigned to the pistons can be controlled in groups or individually. In this case, one or more of the pistons can be separated from the shared gas volume by the respective valve, if necessary, so that the assigned hold-down devices are not pressed on. The valves can be mechanically actuated, e.g. manually.

Advantageously, the valves assigned to the pistons are for instance pneumatically switchable signal-controlled valves, in which case a control device (in particular one with a processor and a memory having stored therein a program for execution by the processor) is advantageously provided, by means of which the valve or valves is(are) opened or closed according to predetermined sequence programs.

In some embodiments, the presser device is designed as a welding mask, in particular such that at least one, several or all of the hold-down devices have a welding beam channel for passing a welding beam for welding the joining partners.

According to a further aspect, the invention provides a joining device for joining battery cells and cell connectors as part of battery module assembly, comprising at least one presser device according to any of the above configurations and a joining device, designed in particular as a welding device, for joining the joining partners pressed together by the presser device. In some embodiments, several joining devices, in particular welding devices, are provided. In particular, if several presser devices are provided, it is preferable to also provide several joining devices, in particular welding devices. The welding device preferably has a welding laser and beam optics for directing the welding beam onto the different joining points at which the hold-down devices press the joining partners together. Instead of a welding process for joining the joining partners, a different joining process, such as crimping or screwing, can also be used.

In some embodiments of the joining device, only one presser device is provided, wherein the second joining partner is held for example by holders, a counter plate or, when joining and pressing from above, a base plate, and the first joining partner is pressed against the second joining partner by means of the presser device.

In some embodiments of the joining device, at least two presser devices are provided, which are arranged opposite each other so that their hold-down devices can move toward each other for pressing. For example, cell connectors for positive poles as first joining partners can be pressed on one side against an arrangement of battery cells as second joining partners by means of a first presser device, while cell connectors for negative poles on the opposite side of the battery cell arrangement are pressed against the battery cells by means of the second presser device.

According to a further aspect, the invention provides a pressing method for pressing at least one first joining partner against at least one second joining partner when joining battery cells with cell connectors as part of battery module assembly, the method comprising:
pressing the at least one first joining partner against the at least one second joining partner by means of a plurality of hold-down devices,
wherein the hold-down devices are each moved by pneumatic pistons which are supplied with the same pressure via a shared pressure source.

For example, a single first joining partner, such as an elongated cell connector, can be pressed by means of a plurality of hold-down devices. If several first joining partners are to be pressed, for instance a plurality of cell connectors, only one (or several) hold-down devices can be used per first joining partner.

In some embodiments, the pressing method is carried out with a presser device according to any of the configurations described above.

In some embodiments of the pressing method, at least one or more cell connectors are pressed simultaneously against several battery cells by means of the hold-down devices controlled in series.

In some embodiments, the cell connectors are contact sheets. In some embodiments, the cell connectors are contact sheets with FPC platelets (FPC=flexible printed circuit, i.e., flexible printed circuit boards).

In some embodiments of the pressing method, cell connectors are pressed against the battery cells on opposite sides of the battery cells.

According to a further aspect, the invention provides a welding method for welding battery cells with cell connectors, the method comprising a pressing method according to any of the above configurations.

The invention relates to devices and methods for pressing one joining partner against another as part of battery module assembly. In particular, cell connectors and battery cells are to be joined together as joining partners, for which one of these joining partners is to be pressed against the other.

For example, if the joining is carried out by welding, welding masks are used for this purpose, which are pressed onto a first joining partner, e.g. a cell connector, in order to press it against the second joining partner, e.g. a battery cell. The joining partners pressed together in this way are then joined, e.g. by welding. Some presser devices are therefore designed as welding masks or welding mask pressers.

Some embodiments relate to a pneumatic welding mask presser for battery modules.

Such a pneumatic welding mask presser is used in the field of battery module assembly.

In some embodiments, the pneumatic welding mask presser is used for welding cell connectors/cell contacting systems with prismatic and/or pouch battery cells, in particular cells in which the positive and negative poles are not located at the top of the cells but laterally, i.e., horizontally on opposite sides.

In some embodiments, the welding masks comprise for instance 1 to 70, in particular at least 2 to 70, welding mask pressers (also known as hold-down devices), which serve to press a cell connector against the respective pole of the battery cell and weld them together (contacting). In some embodiments, one welding mask is used per side of the cell (the positive pole and the negative pole are each arranged on opposite sides of the cell) so that the same number of positive poles (on one side) and negative poles (on the opposite side) are pressed and welded simultaneously with essentially the same pressure. This ensures that the arrangement of the battery cells does not shift due to uneven pressure application (pressure only on one side, or higher on one side than on the other).

Some embodiments of the presser device or the pressing method have one, several, or all of the following advantages in particular:
An even or constant pressing force is generated across all hold-down devices assigned (e.g. located in series). This results in low adjustment or commissioning effort for presser devices, such as welding mask pressers according to embodiments of the invention.
It is possible to restrain certain hold-down devices within the presser device (e.g. welding mask).
During the joining process, such as welding, or during the pressing process, the actual pressing force can be checked or monitored. During the process, the pressing force of the entire system can be monitored, e.g. via pressure switches.
The pressing force can be easily changed; to change the pressing force, it is no longer necessary to manually adjust the preload of pressure springs as previously in prior art, for example by inserting or omitting shims or by manually adjusting a screw connection (to adjust the preload).

Some embodiments create a new welding mask concept to reduce the adjustment effort while increasing process reliability and, preferably, also reducing additional assemblies depending on the workpiece type.

A special concept in embodiments of the invention is to press the hold-down devices by pneumatic pistons that use or form a shared gas volume or are jointly connected to a shared compressed gas source. In some embodiments, the hold-down devices are pressed by pneumatic pistons arranged in series. Due to the pistons using or forming a shared gas volume and connected in series (or parallel), for example, and Pascal's principle, according to which the pressure of a pressurized gas such as compressed air spreads evenly in all directions, it is possible that approximately the same force is applied to all pressers (i.e., all hold-down devices) and that this force can be conveniently controlled by a pressure regulator if necessary—in some embodiments.

By adapting the pressing concept and changing the pressure spring packs using the new pressure concept, a constant pressing force is ensured across all hold-down devices participating in the shared gas volume, e.g., those arranged in series, thereby reducing commissioning and adjustment effort.

The pressing force can be changed by the gas pressure, in particular the air pressure of the system, without direct intervention in the presser device, e.g. the welding mask.

In addition, some embodiments of the invention offer the possibility of retracting individual hold-down devices by means of an interconnection logic within the presser device, e.g. welding mask, and thus not pressing them against the workpiece.

Restraining certain hold-down devices within the presser device, e.g. welding mask, is possible depending on the type of workpiece.

In some embodiments, the pressing force can be monitored during the process by means of a pressure switch. Instead of or in addition to the pressure switch, at least one pressure sensor may also be provided.

Monitoring the pressure enables the detection of failures and/or malfunctions of (individual) hold-down devices during the process.

In preferred embodiments, the cell contacting system and battery cells are pressed simultaneously in series; in particular, one or more cell connectors can be pressed simultaneously against a group, in particular a row, of battery cells. Pressing can take place essentially in a horizontal direction from one or more sides, or in an essentially vertical direction from above or also from below. In some embodiments, the presser device and/or the pressing method is designed to press and weld blade cells or pouch cells which are to be welded in a horizontal position, wherein it is advantageous to press simultaneously from both sides in order to avoid displacement of the battery module to be produced in the event of one-sided or uneven pressure application. In other embodiments, pressure is applied on one side against a counter bearing, such as a support plate, base plate, or the like.

While in the art according to reference [1] a single presser is used, which must operate at a high cycle rate in order to be moved from joining point to joining point, in the presser device according to some embodiments of the invention, 2-100 (in particular 10-100, 20-80, 30-75 . . . ) hold-down devices can be controlled simultaneously, in which case the cycle times of the presser device can be much shorter (i.e. slower) than the cycle times of the system in [1]. This makes the control process, in particular for positioning the hold-down devices, simpler and therefore less complex than with a single presser that has to be moved from joining point to joining point.

In some embodiments, by adapting the pressing concept and changing the pressure spring packs through the new pressing concept, a constant pressing force is ensured across all hold-down devices in series, even with tolerance-related height differences between individual battery cells, thereby reducing commissioning and adjustment effort.

In some embodiments, it is possible to restrain certain hold-down devices within a welding mask or the same presser device depending on the type of workpiece.

In some embodiments, the pressing force of the entire system can be monitored during the process via pressure switches.

In some embodiments, the pressing force can be easily modified by means of a pressure regulator.

### BRIEF DESCRIPTION OF THE DRAWINGS

Examples of embodiments are described in more detail below with reference to the accompanying drawings. In the drawings it is shown by:

FIG. 1 a simplified schematic top view of a joining device according to an embodiment with a presser device according to a first embodiment during joining cell connectors with battery cells, wherein the presser device is represented as a block diagram;

FIG. 2 a simplified schematic top view of a joining device according to a further embodiment with a first and second presser device according to a second embodiment during joining cell connectors with battery cells, wherein the presser devices are represented as block diagrams;

FIG. 3 a simplified schematic block diagram of a presser device according to a third embodiment;

FIG. 4 a simplified schematic block diagram of a presser device according to a fourth embodiment;

FIG. 5 a perspective rear view of a presser device according to a fifth embodiment;

FIG. 6 a perspective front view of the presser device of FIG. 5;

FIG. 7 a sectional view of a joining device with a presser device according to FIGS. 5 and 6, wherein a section through a hold-down device and a pair of pistons for moving the hold-down device of the presser device during a pressing operation is shown; and,

FIG. 8 a section through the presser device similar to FIG. 7 during operation in which the pistons are retracted.

### DETAILED DESCRIPTION OF THE PREFERRED EMBODIMENTS

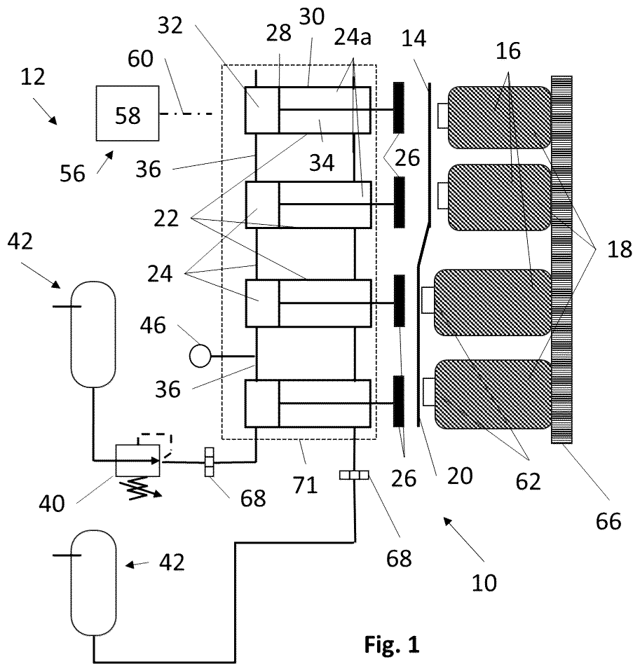

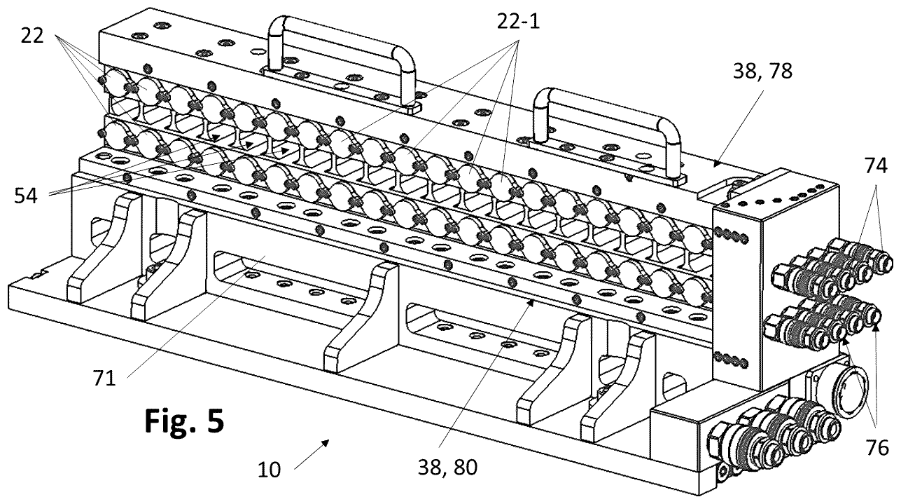

The Figures show different views of a presser device 10 according to different embodiments. In FIGS. 1 to 4, the presser device 10 is shown in different embodiments as a simplified schematic block diagram. In FIGS. 1, 2, and 7, the presser device 10 is shown as part of a joining device 12. FIGS. 5 to 8 show more detailed representations of a possible concrete embodiment of the presser device 10 in a design as a welding mask. The different features of the different embodiments of the presser device 10 explained below can be combined with each other as desired.

As shown in all Figures, the presser device 10 is designed to press at least one first joining partner 14 against at least one second joining partner 16 when joining battery cells 18 and cell connectors 20 during battery module assembly. The presser device 10 comprises several pneumatic pistons 22 which are designed to form a shared gas volume 24 during operation. The presser device 10 further comprises several hold-down devices 26 which are designed to be pressed simultaneously against the at least one first joining partner 14 by means of the pneumatic pistons 22 forming the shared gas volume 24.

The pneumatic pistons 22 (also referred to as cylinders) are linear actuators operated by pressurized gas, such as compressed air, and having a piston element 28 that can move back and forth in a piston housing (cylinder chamber) 30 and is connected to the hold-down device 26. In the embodiments shown, the pistons 22 are double-acting with a first working chamber 32 on one side of the piston element 28, which is supplied with pressure for extension and vented for retraction, and with a second working chamber 34, which is supplied with pressure for retraction and vented for extension.

The first working chambers 32 are connected to each other by connection lines 36 and/or by at least one distribution line 38 to form the shared gas volume 24. In other words, the first working chambers 32 are part of the shared gas volume 24, at least during the pressing operation.

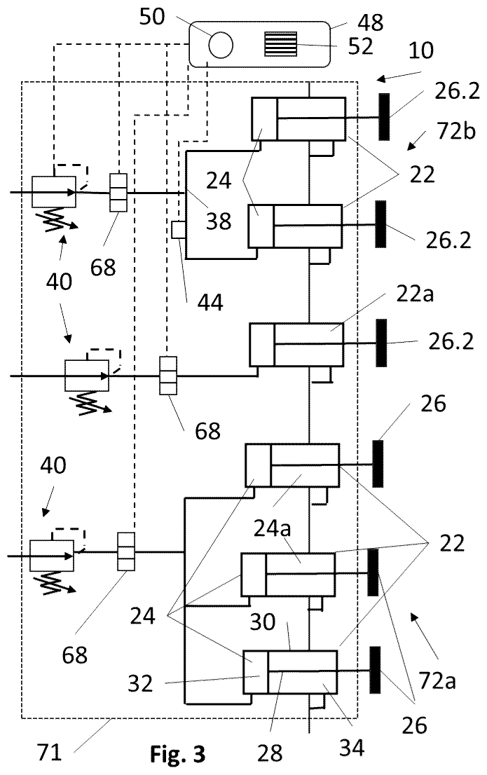

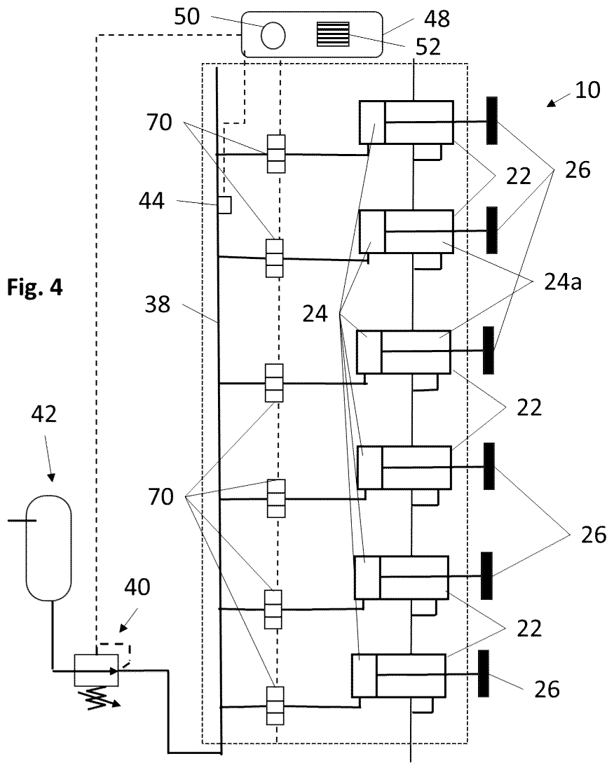

In some embodiments, the shared gas volume 24 is connected to a pressurized gas source 42 (e.g. pressurized gas reservoir, pump) via a pressure regulator 40. In some embodiments, a pressure switch 44 or a pressure sensor 46 is also connected to the shared gas volume 24. The pressure regulator 40 and, if applicable, the pressure switch 44 or the pressure sensor 46 are connected to a control unit 48 (shown in FIGS. 3 and 4 as an example). The control unit 48 has, for example, a processor 50 and a memory 52 in which programs executable by the processor 50 are stored. The control unit 48 can be part of the presser device 10, part of the joining device 12 or external, in particular as part of a plant control system (not shown) for a battery manufacturing plant (not shown).

The pressure regulator 40 can be used to regulate or adjust the contact pressure with which the pistons 22 press on the hold-down device 26. The pressure switch 44 or pressure sensor 46 can be used for functional monitoring of the presser device 10 via the pressure.

In some embodiments, the second working chambers 34 are also connected to each other to form a further shared gas volume 24a for retraction.

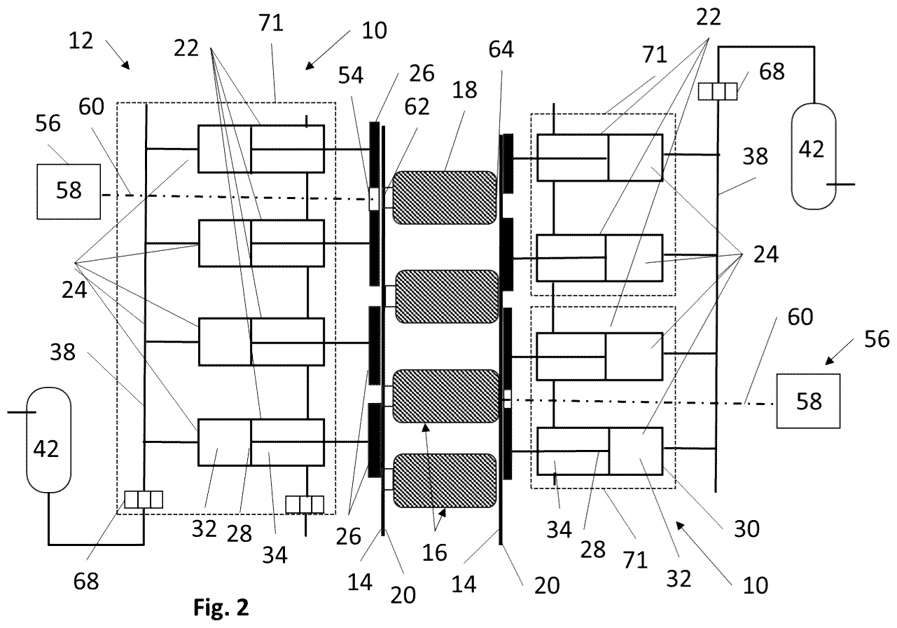

In FIGS. 1 to 4, the presser devices 10 are each shown in a view perpendicular to the direction of displacement. For example, the presser device 10 is arranged so that the pistons 22 are moved substantially horizontally. For example, the presser devices 10 are shown as viewed from above. The pistons 22 can be arranged in pairs, with only the upper piston of each pair being visible. A clearance or passage recess, for example a passage channel 54, can then be formed between the pistons 22 of the piston pair, through which the joining partners can be joined. As shown in FIG. 2, a hold-down device 26 can also be moved jointly by several of the pistons 22. A passage can also be formed between pneumatically actuated pistons 22 that are adjacent to one another on the side.

In the embodiments shown, a joining means 56 of the joining device 12 is designed as a welding apparatus, wherein a joining laser or welding laser 58 is provided, for example, whose laser beam can be directed through the respective passage channel 54 onto the associated joining point. In FIGS. 1, 2 and 7, a possible beam path for the laser beam is schematically indicated at pos. 60.

The presser device 10 has at least one row (or another grouped arrangement) of hold-down devices 26 that simultaneously press the at least one first joining partner 14 against the at least one second joining partner 16 by means of the pistons 22 forming the shared gas volume 24. In particular, the pressing takes place simultaneously at several adjacent joining points.

The first joining partners 14 are, for example, the cell connectors 20 that are pressed against poles 62, 64 of the battery cells 18 as the second joining partners 16. Each cell connector 20 can be pressed by at least one or more of the hold-down devices 26. If several cell connectors 20 are to be pressed, at least one hold-down device 26 is provided per cell connector 20.

As shown in FIG. 1, a single presser device 10 can be provided on one side, in which case a counter bearing 66, e.g. a support plate or (when pressing from top to bottom) a base plate is provided on the opposite side of the joining partners 14, 16.

In other embodiments, such as shown in FIG. 2, a first and a second presser device 10 press against each other on opposite sides, wherein the first presser device 10 presses the cell connectors 20 against positive poles 62 in order to join them with the positive poles 62, and the second presser device 10 presses further cell connectors 20 against negative poles 64 on the opposite side in order to join the further cell connectors 20 to the negative poles 64. On each side, the joining device 12 has at least one joining means 56, for example a welding laser 58.

The pistons 22 forming the shared gas volume can be connected in series, as shown in FIG. 1, with connection lines 36 provided between the adjacent pistons 22. However, the pistons 22 can also be connected in parallel, as shown in FIGS. 2 to 4, in particular to a continuous distribution line 38. Combinations of parallel and series connections are of course also possible. For example, all upper pistons can be connected in series and all lower pistons can be connected in series, with the series of upper and lower pistons connected in parallel to the shared compressed gas source 42. A wide variety of other connection options are possible for forming a shared gas volume 24.

Furthermore, one or more valves 68, 70 may be provided. For example, at least one central valve 68 can be used to switch the respective compressed gas source 42 on or off for extension or retraction. The at least one central valve 68 is controlled in particular by the control unit 48.

As shown in FIG. 3, several groups 72a, 72b of pistons 22 can be provided, wherein the pistons 22 of a group each form a shared gas volume 24 with its own pressure setting—see pressure regulator 40. A single piston 22a can also be controlled separately. Thus, in addition to first hold-down devices 26, which are moved together, at least one or more second hold-down devices 26.2 can be provided, which can be restrained or can also be pressed with a different contact pressure.

In some embodiments, as shown by way of example in FIG. 4, one, several, or all of the pistons 22, which are designed to form a shared gas volume 24, can be provided with their own individual valve 70. Each individual valve 70 is preferably controlled automatically by the control 48 unit as shown. The control can be carried out in different ways, for example electrically in the case of solenoid valves or pneumatically in the case of pneumatically actuated valves, as will be explained in more detail below. The valves 70 can be connected in series, for example. By controlling them together, all pistons 22 can be switched to form the common gas volume 24. To restrain individual hold-down devices 26, the pressure connection between the respective associated valve 70 and the compressed gas source 42 can be omitted.

In alternative designs, the valve 70 of one or more of the pistons 22 can also be controlled individually to switch off the piston 22 so that the associated hold-down device 26 is not actuated.

This makes component-dependent adjustments particularly easy. It is also possible, when the presser device is put into operation, to omit or permanently close access to one or more of the pistons 22 that are not required for the workpiece to be produced, so that only the remaining pistons 22 form the shared gas volume 24.

The pistons 22 are guided in particular in at least one base 71. In particular, the piston housings 30 can be formed integrally in the base 71 so that cylinder spaces are formed next to each other in which the piston elements 28 are movably guided and which form the working chambers 32, 34 between themselves and the piston element 28. In addition, at least part of the connection or distribution lines 36, 38 may be formed as channels in the base 71. Various bores or similar connections may also be provided, through the selection and arrangement of which accesses or connections to the valves 70 and/or the working chambers 32, 34 can be established as required. As shown in FIGS. 1, 3, and 4, a continuous base 71 can be provided for each presser device 10. However, as shown on the right in FIG. 2, a presser device can also have more than one base 71. The multiple bases can be fastened to each other, e.g. screwed together.

In the following, a specific possible embodiment of the presser device 10 designed here as a pneumatic welding mask presser is explained in more detail with reference to FIGS. 5 to 8.

Shown here as an example is a welding mask with twenty hold-down devices 26 connected in series, which are connected via a 4-way connection (as an example) with four connections/couplings 74 that are used to extend the hold-down devices 26, and four connections/couplings 76 that are used to retract the hold-down devices 26. This allows individual control, e.g. restraining of individual hold-down devices.

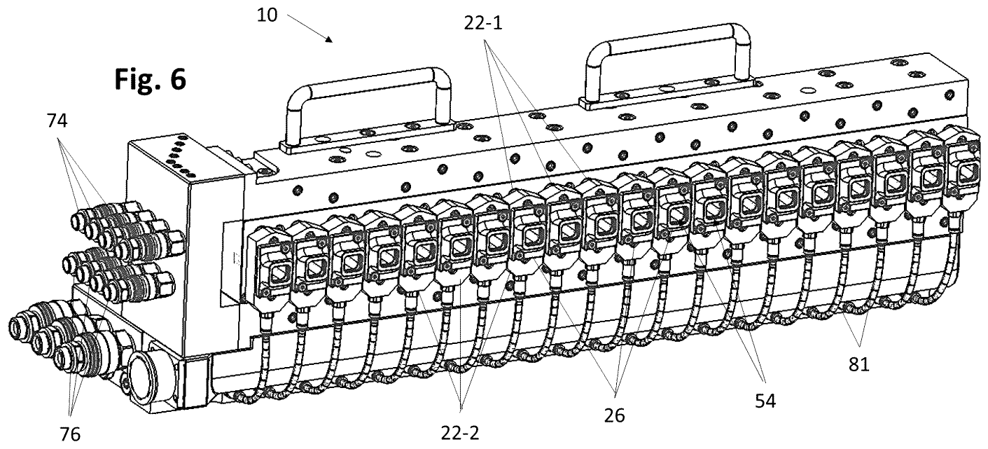

FIG. 5 shows the structure of the pneumatic welding mask on the rear side and FIG. 6 shows the structure of the pneumatic welding mask on the front side.

The presser device 10 has a base 71 in which a first (e.g. upper) row of pneumatic pistons 22, 22-1—hereinafter referred to as first pistons 22-1—and, parallel to this, a second (e.g. lower) row of pneumatic pistons 22, 22-2—hereinafter referred to as second pistons 22-2—are movably guided. At one head end, first pneumatic couplings for instance are provided on the base 71 as first pneumatic connections 74 for extension and second pneumatic couplings as second pneumatic connections 76 for retraction.

As shown in FIG. 6, the pistons 22-1, 22-2 are arranged in pairs, for example, so that a first and a second piston 22-1, 22-2 together actuate a hold-down device 26. In particular, the row of pneumatic hold-down devices 26 or pressers is shown, which are arranged next to each other and can be actuated simultaneously. Each hold-down device 26 has a clearance—e.g. a passage channel 54—for the welding laser 58.

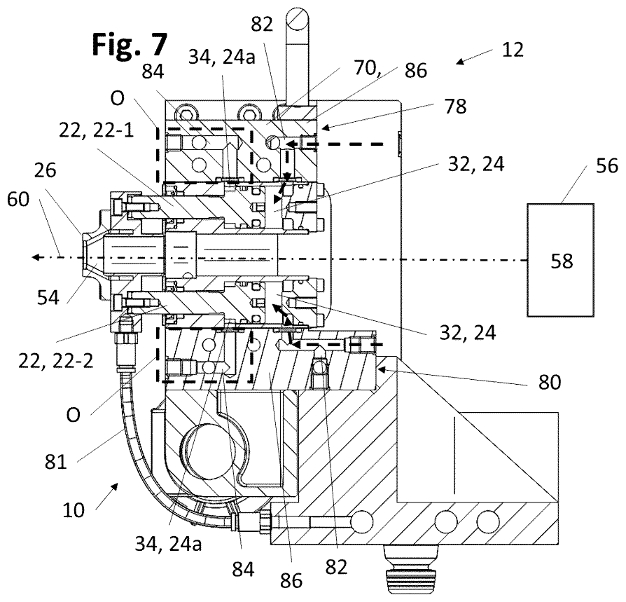

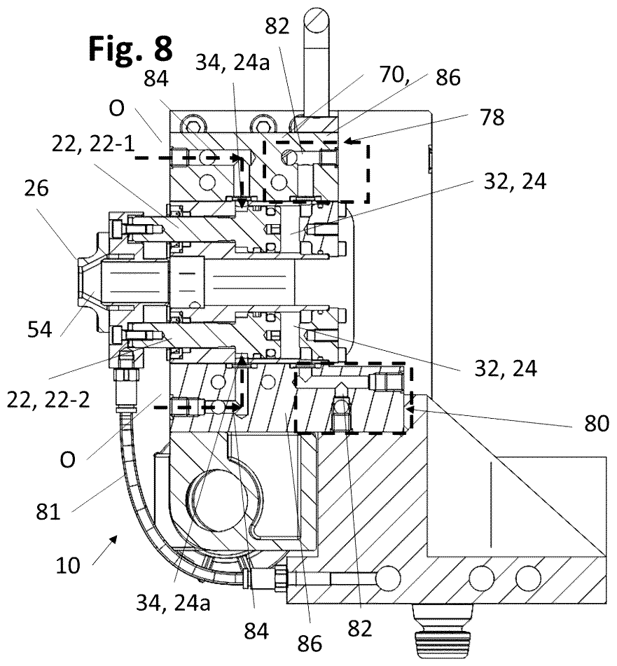

FIGS. 7 and 8 show sectional views of the presser device 10 according to FIGS. 5 and 6, wherein a vertical section through a hold-down device 26 and the associated pair of pistons 22-1, 22-2 is shown. FIG. 7 shows the presser device 10 as part of the joining device 12 during a pressing operation in which the pistons 22-1, 22-2 are extended in order to carry out the joining operation, in particular the welding operation. FIG. 8 shows the drive device in an operating state in which, after pressing, the pistons 22-1, 22-2 begin to retract.

In FIGS. 7 and 8, the first piston (here the upper piston) 22-1, a first distributor block 78 for the first pistons 22-1, a second distributor block 80 for the lower pistons 22-2, the clearance—through-channel 54—for the welding laser 58 and an optional protective gas supply 81 are shown. The distributor blocks 78, 80 each have a first pressurized gas supply 82 (e.g. compressed air supply) for supplying the first working chamber 32 (pressing) and a second pressurized gas supply 84 (e.g. compressed air supply) for supplying the second working chamber 34 (retraction). The distribution blocks 78, 80 have for example one 3/2-way valve 86 per piston 22, 22-1, 22-2 to implement the interconnection for extension/pressing and retraction/restraining.

Although operation is of course possible with different compressed gases, it is described below using compressed air.

The dashed arrows in FIG. 7 indicate the direction of flow of the compressed air for extension/pressing. The second compressed air supplies 84 are open so that air can escape from the second working chambers 34 if necessary. The dashed arrows in FIG. 8 indicate the direction of flow of the compressed air for retraction/restraining. The first compressed air supply lines 82 are open so that air can escape from the first working chambers 32 if necessary.

The following describes the operation of the pneumatic welding mask presser—example for pressing device 10—based on the illustrations in FIGS. 5 to 8.

The pneumatic hold-down devices 26 are controlled via the couplings (connections) 74 and 76. Depending on the interconnection logic (e.g. control logic of the hold-down devices 26) and the typology of the battery module (in particular the number of battery cells 18, the positioning of the battery cells 18 relative to each other in the module, any interfering contours on the module (e.g. plastic lugs on the cell contacting system), individual or multiple hold-down devices 26 can be extended or retracted. The switching logic is implemented via the respective distribution blocks 78 and 80 through various holes in the presser device 10. In designs in which several pistons 22-1, 22-2 are provided per hold-down device 26, the interconnection logic is implemented in such a way that all pistons 22-1, 22-2 of each hold-down device 26 form a shared gas volume 24 during the pressing operation.

The simplest control of the hold-down devices 26 corresponds to a design in which all hold-down devices 26 are controlled via a common compressed air line—see for example FIGS. 1 and 2. In this embodiment, it is not possible to restrain individual hold-down devices 26 while others are extended.

In order to be able to restrain individual (second) hold-down devices 26.2, these can be controlled via a separate compressed air line—see for instance FIG. 3. It may be necessary to restrain hold-down devices 26.2, for example, if different battery modules (different numbers and/or different arrangements of battery cells in the module) are to be manufactured with a welding mask. In some embodiments, this means that it should be known during the manufacture/commissioning of the welding mask which hold-down devices 26 may need to be restrained.

In one embodiment, a welding mask is to be used to produce modules with ten cells (module 1) and modules with twenty cells (module 2). The welding mask then has for instance twenty hold-down devices 26, and if module 1 with ten cells is to be produced, ten hold-down devices 26 must be restrained.

The compressed air flows evenly through the distributor block 78 and 80 into the piston chamber—first working chamber 32—of the pneumatic pistons 22-1 and 22-2 and presses the pistons 22, 22-1, 22-2 and thus the individual hold-down devices 26 forward against the workpiece. Due to Pascal's principle, the pressure is distributed evenly across all hold-down devices 26. The pressure within the lines is actively monitored by a pressure switch 44. The design of the distributor blocks 78, 80 and/or the position of the 3/2-way valve 86, as well as the number of compressed air lines in the welding mask, can be used to determine which hold-down devices are controlled together (or separately). The Pascal principle or the pressure-based control of the hold-down devices 26 makes it possible to compensate for tolerance-related height differences between the battery cells (see the exaggerated illustration in FIG. 1), as the hold-down devices 26 are extended/pressed until the specified pressing force (the specified pressure) is reached. This ensures that all components to be welded—joining partners 14, 16—are held down with the same force, thus creating the zero gap. In other words, the hold-down devices 26 are pressure-controlled and not path-controlled. The joining laser—welding laser 58—can now melt and join the components to be welded—joining partners 14, 16—through the clearances—passage channel 54—within the hold-down devices 26, see FIG. 7. As soon as the welding process is complete, the pressure chamber—first working chamber 32—of the pistons 22-1, 22-2 is vented through the first coupling/first connection 74 and pressure is applied to the piston ring surface—second working chamber 34—via the second coupling/second connection 76, so that the hold-down devices 26 retract again.

A pressing method for pressing at least one first joining partner 14 against at least one second joining partner 16 when joining battery cells 18 with cell connectors 20 as part of battery module assembly has thus been described, the method comprising the step of:
pressing the at least one first joining partner 14 against the at least one second joining partner 16 by means of a plurality of hold-down devices 26, wherein the hold-down devices 26 are each moved by pneumatic pistons 22, 22-1, 22-2 that are supplied with the same pressure via a common pressure source.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 presser device
12 joining device
14 first joining partner
16 second joining partner
18 battery cell
20 cell connector
22 pneumatic piston
22-1 first piston
22-2 second piston
22a individually controllable piston
24 shared gas volume (extension)
24a shared gas volume
26 hold-down device
26.2 second hold-down device
28 piston element
30 piston housing
32 first working chamber
34 second working chamber
36 connection line
38 distribution line
40 pressure regulator
42 compressed gas source
44 pressure switch
46 pressure sensor
48 control unit
50 processor
52 memory
54 passage channel
56 joining means
58 welding laser
60 possible beam path of laser beam
62 positive pole
64 negative pole
66 counter bearing
68 central valve
70 single valve
71 base
72a first group of pistons
72b second group of pistons
74 first connections (for extension)
76 second connections (for retraction)
78 first distributor block
80 second distributor block
81 optional shielding gas supply
82 first compressed gas supply (for first working chamber)
84 second compressed gas supply (for second working chamber)
86 3/2-way valve
O open for air to escape

Claimed is:

1. A presser device for pressing at least one first joining partner against at least one second joining partner when joining battery cells and cell connectors during battery module assembly, comprising:
a plurality of pneumatic pistons configured to form a shared gas volume during operation; and
a plurality of hold-down devices configured to be pressed simultaneously against the at least one first joining partner by the plurality of pneumatic pistons.

2. The presser device according to claim 1, further comprising:
at least one pressure regulator connected to the plurality of pneumatic pistons and configured for controlling a pressing force with which the plurality of hold-down devices press against the at least one first joining partner.

3. The presser device according to claim 1, wherein the plurality of hold-down devices comprises from 2 to 100 hold-down devices.

4. The presser device according to claim 1, further comprising:
at least one second hold-down device associated a pneumatic piston that is configured to controlled separately from the plurality of pneumatic pistons.

5. The presser device according to claim 1, wherein each hold-down device of the plurality of hold-down devices is configured to be moved at least by a first piston and a second piston spaced apart therefrom,
wherein the first pistons and the second pistons of each hold-down device of the plurality of hold-down devices form the shared gas volume.

6. The presser device according to claim 1, further comprising:
a base on which the plurality of hold-down devices are movably guided by the plurality of pneumatic pistons,
wherein the base has at least one compressed gas distributor for distributing compressed gas to the plurality of pneumatic pistons, and
wherein the compressed gas distributor connects a pressure source to the plurality of pneumatic pistons.

7. The presser device according to claim 1, wherein at least piston of the plurality of pneumatic pistons is configured to connect to a common compressed gas source by a separate valve.

8. The presser device according to claim 1, wherein the presser device comprises a welding mask in which at least one hold-down device of the plurality of hold-down devices comprises a welding beam channel for passing a welding beam for welding joining partners.

9. A joining device for joining battery cells and cell connectors as part of a battery module assembly, the joining device comprising:
at least one presser device according to claim 1; and
a welding device configured to join joining partners pressed together by the presser device to one another.

10. The joining device according to claim 9, wherein the at least one presser device comprises at least two presser devices,
wherein the at least two presser devices are arranged opposite each other so that hold-down devices of each presser devices of the at least two presser devices move toward each other for pressing.

11. A method for pressing at least one first joining partner against at least one second joining partner when joining battery cells with cell connectors as part of battery module assembly, the method comprising:
pressing the at least one first joining partner against the at least one second joining partner with a plurality of hold-down devices,
wherein the hold-down devices of the plurality of hold-down devices are each moved by pneumatic pistons which are supplied with a same pressure via a common pressure source.

12. The method according to claim 11, wherein the pressing is performed with a pressive device comprising a plurality of pneumatic pistons which form a shared gas volume during operation and the plurality of hold-down devices configured to be pressed simultaneously against the at least one first joining partner by the plurality of pneumatic pistons.

13. The method according to claim 11, wherein at least one cell connector is pressed simultaneously against several battery cells with the plurality of hold-down devices.

14. The method according to claim 13, wherein cell connectors on opposite sides of the battery cells are pressed against the battery cells.

15. A method for welding battery cells with cell connectors, the method comprising:
performing the method according to claim 11; and
welding the at least one first joining partner and the at least one second joining partner together.
